(19) United States
(12) Patent Application Publication
(10) Pub. No.: US 2006/0267343 A1
(43) Pub. Date: Nov. 30, 2006

(54) Pipe coupling

(76) Inventor: John Peter Wright, Johannesburg (ZA)

Correspondence Address: BIRCH STEWART KOLASCH & BIRCH, PO BOX 747, FALLS CHURCH, VA, 22040-0747, US

(21) Appl. No.: 11/489,487

(22) Filed: Jul. 20, 2006

Related U.S. Application Data
(63) Continuation-in-part of application No. PCT/IB05/02295, filed on Aug. 3, 2005.

(30) Foreign Application Priority Data
Aug. 3, 2004 (ZA) 2004/4606

(51) Int. Cl. F16L 21/06

(52) U.S. Cl. 285/373; 285/419

(57) ABSTRACT

The invention relates to a pipe coupling for rigid plastics pipes having smooth cylindrical ends. The coupling includes a rigid sleeve having a longitudinal bore. Two spaced apart annular grooves are provided in the bore to respectively house deformable annular seals adjacent the ends of the sleeve. O-rings will be used as seals. A harness is securable over the sleeve with pipe engaging teeth adjacent each of the opposite ends. The harness is split longitudinally with a cylindrical passage having an annular recess to receive the sleeve. The teeth are formed by serrated ridges, preferably screw threads, in the passage extending from the recess to the outer ends of the passage. Corresponding lateral lugs on each half of the harness have bolt holes for assembly of the harness over the sleeve. The coupling is particularly suited for connecting plastics pipes used to convey backfill, normally in underground mining operations.

### FIELD OF THE INVENTION

The invention relates to a pipe coupling and more particularly to a coupling for connecting rigid plastics pipes having a smooth cylindrical configuration and which are used in relatively high pressure applications.

### BACKGROUND OF THE INVENTION

Pipe lines are used in a number of applications, usually for conveying liquids or suspensions of particulate material. The latter is often the case in mining operations, normally underground. In fact, plastics pipes have proved successful for use in conveying backfill in the mining industry.

The lines are generally provided by connecting a series of pipes which are manufactured in lengths. The connecting couplings used must in some applications be able to withstand relatively high working pressures. This can be up to 110 bar and sometimes even more.

Working on pipe lines in underground mines must often take place under low light conditions and in confined spaces. It can be difficult to fit a coupling in these circumstances. Along with high working pressures, the underground environment is also harsh and requires a coupling of robust construction.

### OBJECT OF THE INVENTION

It is an object of this invention to provide a pipe coupling that is relatively easy to fit and that provides an effective connection between plastics pipes having smooth cylindrical ends.

### SUMMARY OF THE INVENTION

In accordance with this invention there is provided a pipe coupling, for rigid plastics pipes, comprising a rigid sleeve with opposite ends connected by a longitudinal bore, a deformable seal within the bore and a harness securable over the sleeve with pipe engaging teeth extending beyond and adjacent each opposite end.

The invention further provides for the bore to include a pair of spaced apart annular grooves to receive annular seals; for the grooves to be located one adjacent each opposite end of the sleeve; and for the seals to be O-rings.

Further features of the invention provide for the harness to be longitudinally split with a cylindrical passage having an annular recess for the sleeve; for the teeth to be serrated ridges provided between the recess and outer ends of the passage; and for the teeth to be provided as screw threads.

Further features of the invention provide for each half of the harness to have laterally extending oppositely disposed lugs each having a bolt hole; and for the coupling to be for connecting plastics pipes used to convey mined backfill.

### BRIEF DESCRIPTION OF THE DRAWINGS

The invention will now be described, by way of example only, with reference to the following drawings in which:

FIG. 1 shows a perspective view of an assembled pipe coupling;

FIG. 2 shows a part cross-sectional plan view of the pipe coupling in FIG. 1 connecting a pair of pipes;

FIG. 3 shows an exploded perspective view of the pipe coupling.

### DETAILED DESCRIPTION OF THE INVENTION

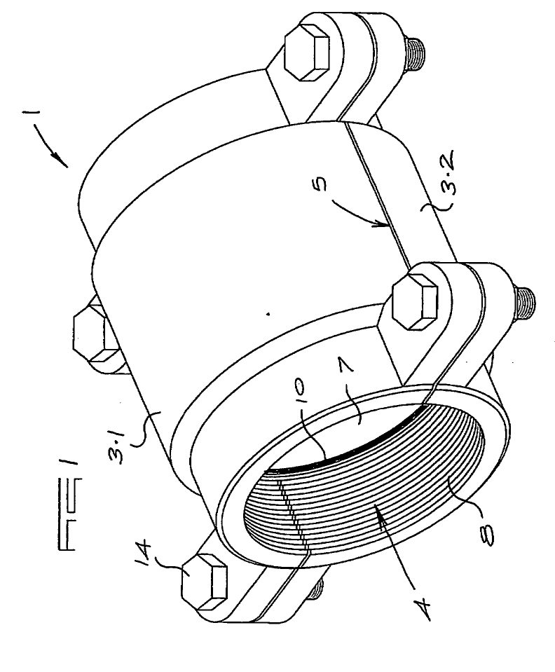

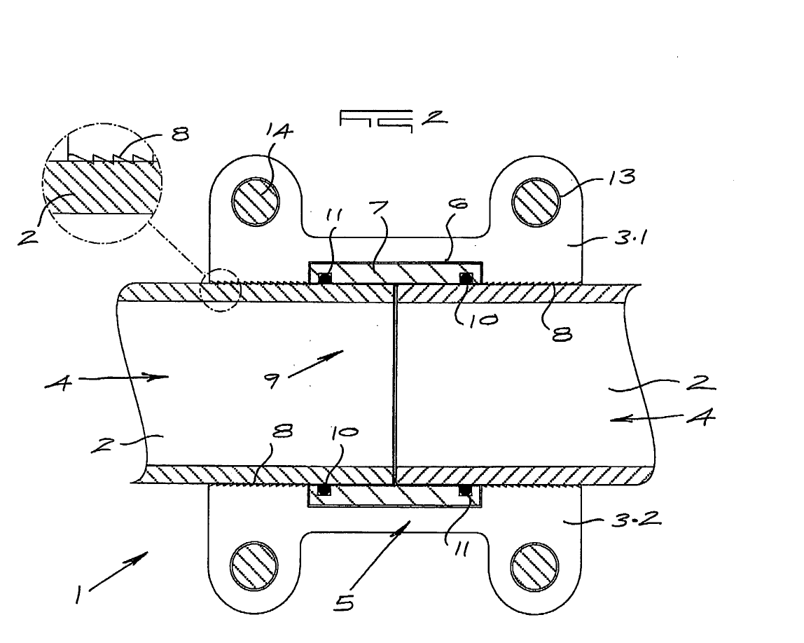

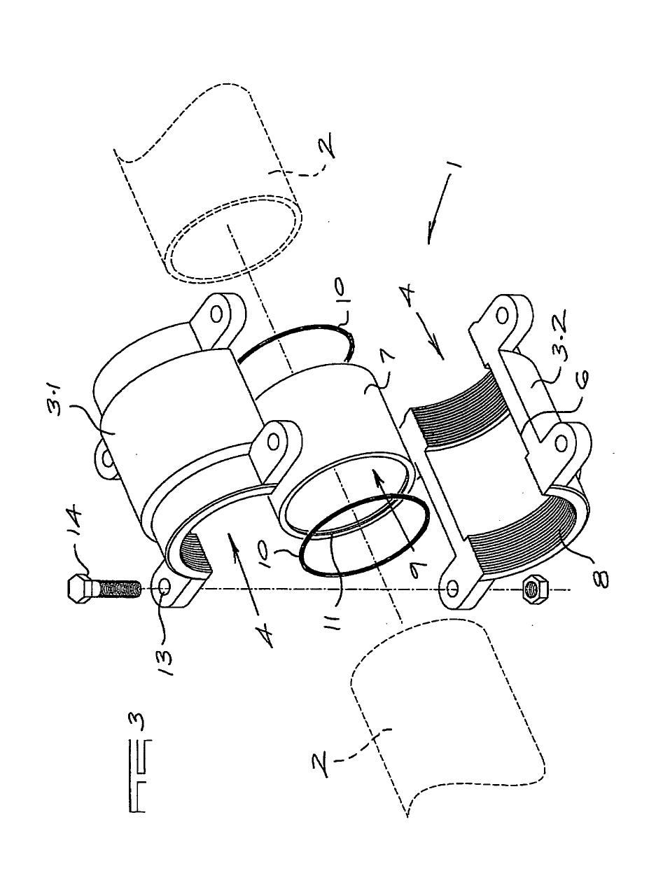

Referring to FIGS. 1 to 3, a pipe coupling (1) in accordance with this invention for connecting the ends of a pair of adjacent aligned pipes (2) is shown. The pipes are plastics and of the rigid kind having smooth cylindrical ends.

The coupling (1) includes a harness (3) with a longitudinal passage (4) extending therethrough. The harness (3) is split at (5) along its length to provide two cooperating halves (3.1) and (3.2). Located centrally in the length of the passage (4) is an annular recess (6). The recess (6) houses a rigid coupling sleeve (7). Pipe engaging teeth (8) are provided in the passage (4) to either side of the recess (6).

The sleeve (7) has a bore (9) with spaced apart internal ring seals (10) secured therein. The ring seals are shown as a pair of O-rings (10). Each of these 0-rings (10) is located in an annular groove (11) adjacent the open ends of the sleeve (7). The inner portions of the O-rings protrude into the bore (9) as required for sealing around a pipe (2).

The teeth are serrated and provided as internal annular ribs (8). These ribs (8) are preferably provided in screw threaded configuration. The teeth (8) are particularly suited for use with hard plastics pipes (2), such as those made from Unplasticized Polyvinyl Chloride (“UPVC”) or High Density Polyethylene (“HDPE”).

The harness (3) includes securing means (12) to secure the two halves to each other. The securing means is provided as laterally extending lugs (12) adjacent the split (5). Each of the lugs (12) has a hole (13) to receive a threaded bolt (14). It will be appreciated that, in use, the securing means (12) will mechanically bias the two halves (3.1) and (3.2) into engagement with each other setting the teeth (8) into the plastics pipes (2).

When connecting adjacent ends of pipes (2) into a pipe line, the sleeve (7) is first fitted completely over the end of one pipe (2). The other pipe end is then located contiguously and the sleeve (7) moved into position overlapping the adjacent ends of both pipes (2). The pipe ends will preferably abut each other within the bore (10). Fitment of the sleeve (7) will be assisted by the use of a suitable lubricant. Once the sleeve (7) is in place, the two halves (3.1) and (3.2) of the harness (3) can be bolted together and clamped over the sleeve (7) with the teeth (8) engaging the pipes (2).

The harness (3) is cast as two halves (3.1) and (3.2) from suitable alloy. The same mould can be used for both halves (3.1) and (3.2). The teeth (8) are provided by machining screw threaded grooves into the half portions which provide the passage (4) as shown. These teeth (8) extend the full length of the passage (4) to either side of the annular recess (6). In the case of the hard plastics pipes referred to, the harness (3) can be cast from cast-iron and the sleeve (7) machined from stainless steel.

Two examples of applications where the coupling (1) will be useful are the conveying of sea water to desalination plants and of backfill in mines. The coupling (1) is particularly suited to overcome some of the difficulties in the latter of these applications.

The steel sleeve (7) wherein the seals (10) are located contains and resists the operational pressure of the fluid in the pipes (2) at the connection. It is the purpose of the harness (3) to restrain the pipes (2) in position with their ends within the sleeve (7) and preferably abutting.

The plastics pipe wall deforms at the relatively high operational pressures, such as that used in underground mines. This deformation may press the seals (10) into their respective grooves (11). The outer surface of the pipe walls may bulge or be pressed into the grooves (11) to some degree. This facilitates frictional engagement of the pipe ends within the sleeve (7) and also in the teeth (8) of the harness (3). The seals (10) are however important to prevent leaking at lower pressures when the pipe walls are not so deformed.

The sleeve (7) is a close fit to the recess (6) when the harness (3) is bolted together. There is however some space or a small tolerance around the sleeve (7) which allows limited movement within the recess (6) when the coupling is not operative. However, in use under pressure the expansion of the pipes resists movement of these components relative to each other.

The coupling (1) includes a minimum number of components for easy and quick removal and replacement, particularly in the dark confines of underground mines. A connection is established that is capable of working at pressures from 120 to 250 bar. The upper pressure limit will usually be determined by failure of the plastics pipes (2) referred to.

While the seals in most prior art couplings are clamped or biased around the pipe ends to establish the required seal, the sleeve (7) of the current invention is made with a tolerance to fit snugly over the ends of the pipes (2). The harness (3) of the current invention is also designed, along with the sleeve (7), to match the diameter of the pipes (2) with which the coupling (1) is to be used. The required secure engagement of the pipes (2) is established when the two halves (3.1) and (3.2) of the harness are (3) tightened against each other. The design allows no margin for over-tightening and so damaging the pipes (2). The teeth (8) of harness (3) engage the pipes circumferentially and substantially uniformly. The harness (3) will not likely stress the structural integrity of the pipes (2) where they are engaged.

The simple design of the coupling (1) allows for cost effective manufacture. It is not only cheaper than a number of prior art couplings but also competent in applications, particularly at relatively high pressures, where most of the prior art would either fail or prove difficult to use.

The configuration of the coupling (1) and its components can be varied to suit the working pressures which must be contained in the pipe lines. The materials from which the coupling and its components are made may also be varied. The harness (3) can be forged, cast or moulded from suitable materials. It may, for example, be moulded from a suitable rigid plastics material. The teeth (8) could also be provided on annular inserts (not shown) split to correspond to the two halves of the harness (3). These inserts would fit into suitable recesses provided within the passage (4) to either side of the sleeve recess (6). Where the teeth (8) are provided on inserts, they can be made separately from more expensive materials and to greater precision, where this is required.

Pressure assisted lip seals or seals of any other suitable type may also be used in the sleeve (7). The number of seals (10) which the sleeve accommodates may also be increased. The sleeve (7) may be provided with an internal liner (not shown) which will be resistant to wear. The liner may be made of ceramics or other suitable materials.

Furthermore, the coupling (1) can be provided with a hinge (not shown) along the split on one side of the harness (3) and the securing means, as described, to hold it together on the other side. The lugs (12) on the harness (3) may also be replaced by suitable clamps (not shown). Such clamps may be made, for example, from a pair of cooperating semicircular plates bent to shape with outwardly extending flanges provided at their free ends and corresponding bolt holes through the flanges. Other alternative securing means (12) which include circumferential clamps with some sort of mechanism for biasing the two halves (3.1) and (3.2) against each other may also be used.

It will be appreciated that a coupling (1) with such a recess (6) and sleeve (7) arrangement could also be provided as a T-joint or some other configuration for connecting more than two pipe ends.

1. A pipe coupling, for rigid plastics pipes, comprising a rigid sleeve with opposite ends connected by a longitudinal bore, a deformable seal within the bore and a harness securable over the sleeve with pipe engaging teeth extending beyond and adjacent each opposite end.

2. A coupling as claimed in claim 1 in which the bore includes a pair of spaced apart annular grooves to receive annular seals.

3. A coupling as claimed in claim 2 in which the grooves are located one adjacent each opposite end of the sleeve respectively.

4. A coupling as claimed in claim 3 in which the seals are O-rings.

5. A coupling as claimed in claim 1 in which the harness is longitudinally split and provides a cylindrical passage having an annular recess for the sleeve.

6. A coupling as claimed in claim 5 in which the teeth are serrated ridges provided between the recess and outer ends of the passage.

7. A coupling as claimed in claim 6 in which the teeth are provided as screw threads.

8. A coupling as claimed in claim 5 in which each half of the harness has laterally extending oppositely disposed lugs each having a bolt hole.

9. A coupling as claimed in claim 1 for connecting plastics pipes used to convey mined backfill.
